(19) United States
(12) Patent Application Publication
(10) Pub. No.: US 2004/0092380 A1
(43) Pub. Date: May 13, 2004

(54) Aluminum oxide ceramic components and methods

(75) Inventors: Frank Anderson, Golden, CO (US); Steven M. Landin, Conifer, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CoorsTek, Inc., Golden, CO (US)

(21) Appl. No.: 10/612,280

(22) Filed: Jul. 1, 2003

Related U.S. Application Data
(60) Provisional application No. 60/393,347, filed on Jul. 1, 2002.

(51) Int. Cl. C04B 35/10

(52) U.S. Cl. 501/127; 501/153

(57) ABSTRACT

A method for making an aluminum oxide (Al₂O₃) component utilizes an amount of aluminum oxide in particle form. The aluminum oxide initially has less than about 100 parts per million of sodium and less than about 600 parts per million of silica. The aluminum oxide is ground with media that comprise aluminum oxide ceramic pieces that have less than about 200 parts per million of sodium to deagglomerate and reduce the particle size of the aluminum oxide. The ground aluminum oxide is placed into a slurry, and a low sodium grade binder is added to the slurry. The slurry is dried to provide an aluminum oxide powder having a sodium content that is less than about 200 parts per million. The powder may then be formed into a certain shape and thermally treated to produce an aluminum oxide component having a low sodium and low silica content.

### CROSS-REFERENCES TO RELATED APPLICATIONS

This application claims priority to U.S. provisional patent application Ser. No. 60/393,347, filed on Jul. 1, 2002, and entitled “ALUMINUM OXIDE CERAMIC COMPONENTS AND METHODS,” which is hereby incorporated by reference in its entirety.

### BACKGROUND OF THE INVENTION

This invention relates generally to the field of ceramics, and in particular to high purity ceramics. More specifically, the invention relates to high purity aluminum oxide ceramics and methods for making such ceramics.

Ceramics are highly utilized in many of today's technologies. For example, ceramics are widely used in making semiconductors. Ceramics are also used in microwave applications, such as power transmission and communication applications, among others. Many of these applications require the ceramic to have a high level of purity. For example, in semiconductor applications, if ceramic parts used in the process have excess sodium, the sodium may leach out of the ceramic and contaminate the wafer. Indeed, even ceramics containing about 10¹³ to about 10¹⁴ impurity atoms per square centimeter (corresponding to a 99.5% purity) may be too high for many semiconductor applications. As another example, excess silica may make the ceramic susceptible to degradation during semiconductor etching processes. In applications were electromagnetic radiation is directed through a piece of ceramic, excess impurities may alter the dielectric behavior of the ceramic. This in turn may cause excessive power dissipation and heating of the ceramic. As a further example, ceramics are often used as resonator supports in cell phone base stations. Impurities in the ceramic may create unwanted losses that dissipate the transmission signals.

While techniques do exist for significantly reducing the amount of impurities, such processes can be prohibitively cost expensive. For example, aluminum oxide has been produced by placing sodium aluminate into acid. This process is expensive and results in a powder that is not process friendly and is difficult to sinter. Hence, this invention relates to high purity ceramics and methods for making such ceramics that are economically justifiable.

### BRIEF SUMMARY OF THE INVENTION

The invention provides various high purity ceramics as well as methods for making such high purity ceramics. For example, in one embodiment the invention provides a method for making an aluminum oxide (Al₂O₃) component. The method utilizes an amount of aluminum oxide in particle form. The aluminum oxide initially may have less than about 100 parts per million of sodium and less than about 600 parts per million of silica. The aluminum oxide is ground with media that comprise aluminum oxide ceramic pieces that have less than about 200 parts per million of sodium to deagglomerate and reduce the particle size of the aluminum oxide. The ground aluminum oxide is placed into a slurry, and a low sodium grade binder is added to the slurry. The slurry is dried to provide an aluminum oxide powder having a sodium content that is less than about 200 parts per million and a silica content of less than about 1500 parts per million. The powder may then be formed into a certain shape and thermally treated to produce an aluminum oxide component having a low sodium and low silica content. For example, the aluminum oxide component may have a purity of about 99.8% or greater. Further, such a process is relatively inexpensive so that the component may be produced at an economically viable cost.

Another advantage of such a component is that it may have a relatively small dielectric loss value, e.g., of less than about 5×10⁽⁻⁵⁾. Such a low dielectric loss value is useful in reducing the amount of power dissipation and heat generated during applications where electromagnetic radiation is passed through the ceramic component.

The aluminum oxide that is provided in particle form may be obtained from mined bauxite. The bauxite in turn may be processed to separate the aluminum oxide from other components and then washed to remove as much of the sodium as possible.

After the grinding step, the aluminum oxide may have a mean particle size in the range from about 0.5 microns to about 4 microns. In another aspect, the ground aluminum oxide may be placed into the slurry using a wet mill process having media that comprise aluminum oxide ceramic pieces that have less than about 200 parts per million of sodium. Conveniently, the slurry may be spray dried to form the powder. In a further aspect, the binder may comprise polyethylene glycol, although other binders may be used as well. In one aspect, the powder is thermally treated at a temperature in the range from about 1580 degrees C. to about 1670 degrees C. for about 2 to about 10 hours.

In another embodiment, the invention also provides various high purity ceramic members. The ceramic members may each comprise a ceramic component that is composed of aluminum oxide, with the aluminum oxide comprising at least about 99.8% of the ceramic member. Further, the aluminum oxide was formed from aluminum oxide particles initially having less than about 100 parts per million of sodium and less than about 600 parts per million of silica. These particles in turn were ground with media that may comprise aluminum oxide ceramic pieces that have less than about 200 parts per million of sodium and less than about 1,500 parts per million of silica.

The ceramic member may contain less than about 200 ppm of sodium, and less than about 1,500 ppm of silica. Further, because of its purity, the ceramic member may be used in a variety of applications. For example, the ceramic component may be fashioned in the shape of a cell phone base station, in the shape of a vacuum chamber cover, in the shape of a semiconductor manufacturing part, or the like.

### BRIEF DESCRIPTION OF THE DRAWINGS

FIG. 1 is a flow chart illustrating one method for producing an aluminum oxide component according to the invention.

FIG. 2 is a schematic diagram of a semiconductor manufacturing apparatus vacuum cover according to the invention.

FIG. 3 is a schematic diagram of a cell phone base according to the invention.

FIG. 4 is a schematic diagram of a glue curing system utilizing a microwave window according to the invention.

### DETAILED DESCRIPTION OF THE INVENTION

The invention provides exemplary high purity ceramics and methods for making such ceramics. In one aspect, the ceramics comprise aluminum oxide having a purity of about 99.8% or greater. Such a level of purity enables components made from the ceramic to be used in a wide variety of applications that demand such purity. For example, the ceramics may be used in a wide variety of semiconductor manufacturing processes that require a low sodium and silica content. The high purity ceramics limit the amount of contaminates that may leach out onto the wafer and are also chemically stable during a given etching process. Such ceramics also have a low dielectric loss value. This permits electromagnetic energy, such as microwaves, to be transmitted through the ceramics without excessive heat generation. Importantly, the processes of the invention may be implemented in a cost effective manner so that the resulting ceramic components may be competitively marketed.

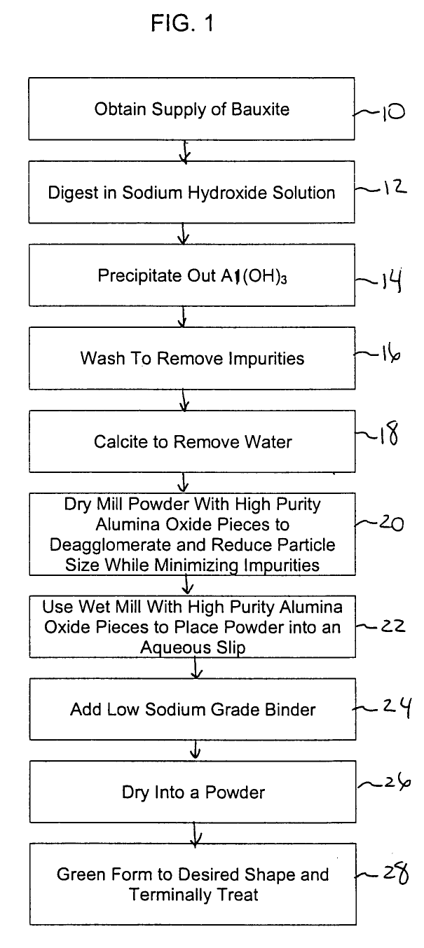

Referring now to FIG. 1, one method for producing a high purity ceramic, such as aluminum oxide ceramic, will be described. As shown in step 10, the process may use as its starting material mined bauxite. To extract the aluminum oxide from the bauxite, the bauxite is digested into a sodium hydroxide solution as shown in step 12. The resulting red liquor is decanted off, and Al(OH)₃ is precipitated out as shown in step 14. A washing process may then be employed to remove as much sodium and other impurities as possible as shown in step 16. The Al(OH)₃ may then be calcined at about 1200° C. to drive off water and produce aluminum oxide (Al₂O₃) as shown in step 18. At this point, the aluminum oxide may have a sodium content that is less than about 100 ppm, more preferably less than about 50 ppm, and still more preferably less than about 25 ppm, and a silica content that is less than about 600 ppm, preferably less than about 500 ppm, and more preferably less than about 400 ppm.

The aluminum oxide may then be subjected to a dry mill process to deagglomerate the powder and to reduce the particle size. For example, the dry mill process may produce particles having a mean size in the range from about 0.5 microns to about 4 microns. The dry mill process utilizes ceramic pieces to reduce the particle size as shown in step 20. Advantageously, the ceramic pieces may be formed of a high purity aluminum oxide ceramic. In this way, as the ceramic pieces wear during the milling process, the powder being milled is not contaminated by particles shed from the ceramic pieces. Conveniently, the ceramic pieces may also be produced using the process set forth in FIG. 1 and may have a sodium content that is less than about 200 ppm, and more preferably less than about 100 ppm, and more preferably less than about 50 ppm. Further, the ceramic pieces may have a sodium content that is less than about 1,500 ppm, and more preferably less than about 1,000 ppm, and still more preferably less than about 800 ppm. The dry mill process may utilize standard equipment as is known in the art. The ball mill may be operated from about 8 hours to produce the desired size.

Once deagglomerated, the aluminum oxide powder is placed into an aqueous slip as shown in step 22. The aqueous slip may include one or more additives that are selected to have a minimal amount of impurities, such as sodium and silica, so that the resulting raw batch mixture will also have minimal impurities. Examples of such additives may include de-foamers, dispersants, binders, plasticizers, and the like. Further, an amount of magnesium carbonate may be added to control grain growth. One example of a low impurity dispersant is ammonium lignosulfate. Examples of suitable additives that have minimal sodium content and that control grain growth, as well as dispersants that may be used are described in “Ceramics and Glasses,” Volume 4, Engineered Materials Handbook, ASM International, 1991, the complete disclosure of which is herein incorporated by reference.

A binder is also added to the slip as shown in step 24. The binder may be a low sodium binder, such as polyethylene glycol. The binder is used to impart sufficient strength and desirable elastic properties to the subsequently formed green body during thermal processing as described hereinafter. Examples of other low sodium binders that may be used include polyvinyl alcohol, as well as those found in the Engineering Materials Handbook as previously described. The low sodium additives, dispersants, binders and the like permit the resulting powder to maintain its high level of purity (with minimal silica and sodium).

A wet ball mill process is used to place the aluminum oxide into the aqueous slip. The media used in the wet mill process may be the same media used in the dry mill process, i.e., high purity aluminum oxide ceramic pieces. The wet ball mill may be operated for about 4 hours to place the aluminum oxide powder into the aqueous slip.

As shown in step 26, a drying process is used to remove the liquids and produce a raw batch mixture. A variety of drying processes may be used. For example, the aqueous slip may be spray dried, pan dried or the like. When spray drying, the drier is preferably cleaned to remove any contaminants. The resulting raw batch mixture comprises from about 95 wt % to about 98 wt % of aluminum oxide, from about 2 wt % to about 5 wt % of the binder, and from about 0 wt % to about 2 wt % of other additives. More preferably the powdered raw batch mixture comprises about 96 wt % to about 97 wt % of aluminum oxide, from about 3 wt % to about 4 wt % of the binder, and from about 0 wt % to about 1.5 wt % of other additives. Further, the raw batch mixture (after the wet mill process) has a sodium content that is less than about 200 ppm, more preferably less than about 100 ppm, and still more preferably less than about 25 ppm. The raw batch mixture also has a silica content that is less than about 1,500 ppm, more preferably less than about 1,000 ppm, and still more preferably less than about 80 ppm.

Hence, the resulting raw batch mixture is relatively free from impurities. Further, the process for producing the raw batch mixture from bauxite while using traditional dry and wet mill processes is relatively inexpensive while still maintaining a high degree of purity.

As shown in step 28, the raw batch mixture may be formed into a green body using any of the techniques known in the art. Forming processes that may be used, for example, include casting, extrusion, dry pressing, isostatic pressing and the like. To dry press the raw batch mixture, the mixture is placed into a die cavity having a desired shape. The mixture is then pressed or compacted within the die to produce a compacted mixture. The compressed mixture is then removed from the die in the form of a green body. The green body may roughly have the shape of the end product and may have the shape of any of the components described herein.

The green body is then thermally treated using any of the techniques known within the art to produce an aluminum oxide component. For example, the green body may be fired in a suitable furnace at a suitable temperature, pressure, heating and cooling rate and atmospheric compositions to cause sintering to occur. Merely by way of example, the green body may be fired at a temperature in the range from about 1580° C. to about 1670° C., and more preferably at about 1650° C. for about two hours to about ten hours, and more preferably for about four hours in air.

The formed ceramic component may be shaped into a final end product using a variety of finish steps, such as by grinding, lapping, polishing, or the like. Examples of various components that may be used are described hereinafter.

The resulting ceramic component preferably comprises at least about 99.8% by weight of aluminum oxide. Further, the ceramic component preferably has less than about 200 ppm, and more preferably less than about 100 ppm, and more preferably less than about 50 ppm of sodium, and less than about 1,500 ppm, and more preferably less than about 1,000 ppm, and more preferably less than about 800 ppm of silica. The ceramic component may also have a dielectric loss value (also referred to as a dissipation factor or loss tangent) of less than about 5×10⁻⁵, more preferably less than about 4×10⁻⁵, and most preferably less than about 3×10⁻⁵ across an operating range of about 1 mega Hz to about 100 Giga Hz, and more preferably from about 1 Giga Hz to about 10 Giga Hz.

Because of these characteristics, the aluminum oxide ceramics of the invention may be used in a wide variety of applications. For example, aluminum oxide ceramic components may be used in a wide varied of semiconductor manufacturing apparatus. The high purity of the ceramics, and especially the low amount of sodium, permits them to be used in applications where during the manufacturing process, sodium would otherwise leach out and sputter onto the substrate being processed. The low silica content also makes the components resistant to etching processes used in processing semiconductors. Further, the low dielectric loss or dissipation factor permits RF current to be passed through the ceramics with reduced power dissipation and therefore reduced heating. The cost to prepare the powders may be up to about 5 times less expensive than producing the powders from sodium aluminate that is placed into acid. Further, processing of the powders into a ceramic may be up to about 5 times less expensive than with powders obtained from sodium aluminate.

Hence, the high purity ceramics of the invention may be used as part of a manufacturing apparatus that may potentially be eroded due to the harsh conditions employed in such processes. Merely by way of example, the ceramics of the invention may be used to construct an electron cyclotron resonance source reactor, a helical source reactor, a plasma reactor, other types of reactors, dielectric domes or windows that cover treatment chambers, wafer polishing plates, pad dressers, carrier plates, vacuum chucks, nozzles, end effectors, chamber windows and tubes, components of stages, focus rings, clamp rings to hold the wafer in place, gas distribution plates held above the wafer, and the like.

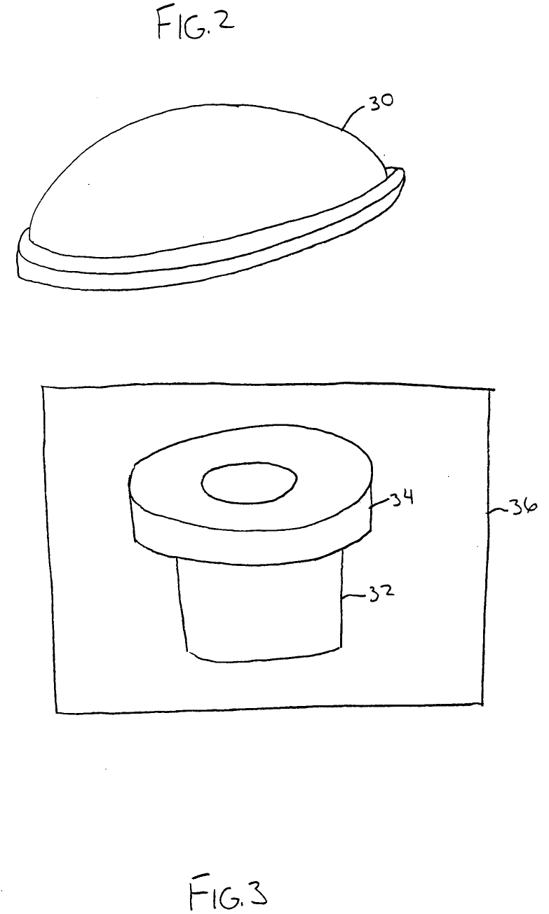

As one specific example, FIG. 2 illustrates a dielectric dome 30 that may be constructed of an aluminum oxide ceramic. Dome 30 may be hemispherical in shape to provide balanced RF coupling. Further, dome 30 has sufficient structural integrity so that it may withstand a vacuum. As is known in the art, an induction coil may be positioned about dome 30 while a semiconductor wafer may be held beneath dome 30.

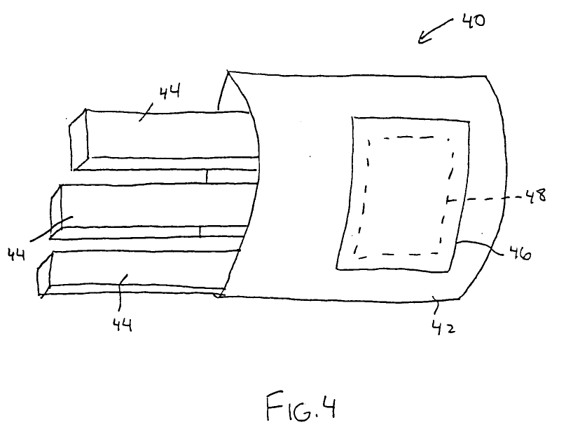

The high purity ceramics of the invention may also be used as resonator supports for resonators that transmit energy. The ceramic supports provide minimal loss to the resonator so that its signal does not significantly dissipate. For instance, as shown in FIG. 3, the ceramics of the invention may be used to form a support 32 that supports a resonator 34, such as a titinate dielectric material, used in cell phone base stations. As is known in the art, the resonator 34 and support 32 are held within a metal can 36 that is typically positioned near a cell phone tower. The resonator 34 finctions as a filter to permit only a certain band of frequencies to pass through. By minimizing any losses (due to the use of support 32), resonator 34 is able to permit its proper function. Support 32 may have a dielectric loss value that is greater than sapphire to perform this finction. For example, the dielectric loss value may be less than about 5×10(−5), more preferably less than about 4×10(−5), and still more preferably, less than about 3×10(−5).

As another example, the aluminum oxide ceramics of the invention may be used in applications requiring the transmission of electromagnetic radiation, such as microwave energy. For example, shown in FIG. 4 is bonding apparatus 40 that comprises a tube 42 into which boards 44 are placed along with an amount of glue. Tube 42 has an aluminum oxide ceramic window 46 and a microwave source 48. Microwave energy is passed through window 46 to cure the glue and bond boards 44 together. By having a low dielectric dissipation factor or dielectric loss value, power losses are reduced to in turn reduce heating during the curing process.

The invention has now been described in detail for purposes of clarity and understanding. However, it will be appreciated that certain changes and modifications may be practiced within the scope of the appended claims.

What is claimed is:

1. A method for making an aluminum oxide component, the method comprising:
providing an amount of aluminum oxide in particle form, wherein the aluminum oxide has less than about 100 parts per million of sodium and less than about 600 parts per million of silica;
grinding the aluminum oxide with media that comprise aluminum oxide ceramic pieces that have less than about 200 parts per million of sodium to deagglomerate and reduce the particle size of the aluminum oxide;
placing the ground aluminum oxide into a slurry;
adding a low sodium grade binder to the slurry;
drying the slurry to provide an aluminum oxide powder having a sodium content that is less than about 200 parts per million;
forming the powder into a certain shape; and
thermally treating the formed powder to produce an aluminum oxide component having a low sodium and low silica content.

2. A method as in claim 1, wherein the powder is thermally treated at a temperature in the range from about 1580 degrees C. to about 1670 degrees C. for about 2 to about 10 hours.

3. A method as in claim 1, wherein the aluminum oxide component has a dielectric loss value that is less than about 5×10(−5).

4. A method as in claim 1, wherein the binder comprises polyethylene glycol.

5. A method as in claim 1, wherein the slurry is spray dried.

6. A method as in claim 1, wherein the aluminum oxide has a purity of at least about 99.8%.

7. A method as in claim 1, wherein the component is selected from a group consisting of a microwave window, a cell phone base, and a semiconductor manufacturing component.

8. A method as in claim 1, wherein the aluminum oxide in particle form is produced from mined bauxite.

9. A method as in claim 1, wherein the ground aluminum oxide is placed into the slurry using a wet mill process having media that comprise aluminum oxide ceramic pieces that have less than about 200 parts per million of sodium.

10. A method as in claim 1, wherein the aluminum oxide has a mean particle size in the range from about 0.5 microns to about 4 microns after the grinding step.

11. A ceramic member, comprising:
a ceramic component comprising aluminum oxide, wherein the aluminum oxide comprises at least about 99.8% of the ceramic member, wherein the aluminum oxide was formed from aluminum oxide particles having less than about 100 parts per million of sodium and less than about 600 parts per million of silica, and that was ground with media that comprise aluminum oxide ceramic pieces that have less than about 200 parts per million of sodium.

12. A ceramic member as in claim 11, wherein the ceramic member contains less than about 200 ppm of sodium.

13. A ceramic member as in claim 11, wherein the ceramic member contains less than about 1,500 ppm of silica.

14. A ceramic member as in claim 11, wherein the ceramic component is fashioned in the shape of a cell phone base station.

15. A ceramic member as in claim 11, wherein the ceramic component is fashioned in the shape of a vacuum chamber cover.

16. A ceramic member as in claim 11, wherein the ceramic component is fashioned in the shape of a semiconductor manufacturing part.
